(19) United States
(12) Patent Application Publication
(10) Pub. No.: US 2015/0186430 A1
(43) Pub. Date: Jul. 2, 2015

(54) CELL PHONE BUSINESS REGISTER SYSTEM

(71) Applicants: John Heffernan, Setauket, NY (US); Neil P Heffernan, Setauket, NY (US)

(72) Inventors: John Heffernan, Setauket, NY (US); Neil P Heffernan, Setauket, NY (US)

(21) Appl. No.: 14/579,622

(22) Filed: Dec. 22, 2014

Related U.S. Application Data
(60) Provisional application No. 61/921,057, filed on Dec. 26, 2013.

(51) Int. Cl. G06F 17/30; H04L 29/06; G06F 3/0481

(52) U.S. Cl. CPC G06F 17/30289; G06F 3/04817; H04L 29/06965

(57) ABSTRACT

A computer system programmed to provide a user interface (UI) enabling cell phone access to a database system configured as a business directory and information service in order to search and identify registered businesses based on a business class, location or name and search stored business information related to the identified business in order identity contact data for personnel designated for client contact in relation to the stored information. The system includes a database system programmed to manage indexing, storing and retrieving the business information and contact data and a computer server that operates the user interface (UI) and a communication function that establishes and manages secure communications with client-side application program operating in a client cell phone to enable the client to search the stored business information for business personnel most closely associated with the searched business and access the contact data for said business personnel.

### CROSS-REFERENCE TO A RELATED APPLICATIONS

The invention described and claimed hereinbelow claims priority under 35 USC §120 from U.S. Provisional Patent Application Ser. No. 61/921,057, filed Dec. 26, 2013, the contents of which are incorporated by reference herein.

### BACKGROUND OF THE INVENTION

The invention relates broadly to wireless telephone applications and more specifically relates to a client-server system in which access to and navigation within a database operating as business directory and information service is provided to cell-phone clients through a unique user interface that enables the cell phone clients to identify a business registered therein, based on business interest, location, class and/or name, search information provided by the business for sales, marketing, customer relations, technical, billing, financial, research & development (R&D) services (without limitation) to access identity and contact information of personnel designated for client contact regarding the services. Preferably, the designated personnel contact information comprises a telephone number to a cell phone provided by the business and/or an email address accessible through an e-mail service, also provided by the business.

Systems and methods for operating business directories are known. In many cases, businesses their personnel with cell phones for communication with customers (i.e., clients) with the expectation of generating or facilitating business. For that matter, the business operating in this manner also will provide a cell phone register that enables the clients or customers to get in direct contact with the specific company personnel via the cell phones. Independent sale representatives having their name and number associated with their respective companies can have clients and customers communicate directly, increasing business opportunities.

Along those lines, pending US Published Application Serial No. 20050159137 to Ramirez, et al., discloses a method that enables the customers to access residential, business or government directory information on a city, state or federal level from a cell phone. The user selects a directory a local or national option from a main menu listing and then identifies whether the information sought is residential, business or government. The customer the enters one of the following: last name, business name, business category, or the first letter the specific option the customer is searching for, whereby an alphabetical list under the entered request is provided. Autodial and save functions are available.

U.S. Pat. No. 6,823,373 to Pancha, et al., provides a mobile data communication system which couples application specific remote data sources and mobile devices via an internet based server that provides an interface for extracting data from the application specific remote data sources. The extracted data is then generalized into generic objects and presented on the mobile devices by device specific application templates, at the application specific remote data sources. Put another way, the invention disclosed by Pancha provides an application interface to enterprise, personal and public data, accessible in a personalized, contextual workflow via voice, wireless devices and the Web.

U.S. Pat. No. 8,335,495 to Haleem provides an interface between an incoming caller and an automated response system. In greater detail, Haleem provides a cell phone application program with graphical display capability and the digital data communication capability to present a customized directory of a called enterprise on a display screen, the display enabling the connected caller to identify their desired call destination by name. A directory database stores directory information for each call destination of the enterprise, whereby the call causes a directory manager to send requests for user data to cell phone application program, whereupon at delivery of responsive data, the cell phone manager evaluates at least one access rule to select relevant directory information from the directory database, provides the connected caller with relevant directory information, in such a way that allows the connected caller to select as specific call destination based on the displayed directory information.

### SUMMARY OF THE INVENTION

In many cases, businesses, corporations, companies, organizations, etc. (referred to hereinafter as business entity or entities) supply their personnel, employees and associates with cell phones and email services, the email services including providing e-mail addresses at which the employee receives electronic mail. As used herein, “cell phone” should be interpreted broadly as any known wireless communication device, such as a mobile phone, smartphone, configured for transmitting and receiving wireless signals, land line signals, data signals, text signals and messages.

The invention enables the general public or interested parties requiring access to business personnel to use their cell phones to get in contact directly and immediately with the proper business personnel to meet their ends, thus improving efficiency and effectiveness, saving time, contributing to improved business relations and commerce for the business.

In an embodiment, a system operates to allow businesses and companies that supply their personnel, employees, and associates with cell phones and e-mail addresses, register the names, cell phone and email address in a database (i.e., personnel contact information) and provide direct connection and access to the personnel contact information via the Internet by a server managing the system. Preferably, a cell phone application operational on client cell phones interact with a server operating the database. The server operates and a user interface that provides display screen images to the cell phone client that enable the client to select a registered business by business category, then select a subject matter of the client's interest, then select a search and select option, then review displayed businesses of various locations, sales values, related subsidiaries and management with the closest selected names and cell phone numbers associated therewith.

Upon identifying a person to be accessed, the accessing client merely clicks on his/her name. A display screen is then presented in the client-side UI with a phone or other icon that is “clicked on” or otherwise selected to initiate a phone call (i.e., voice communication) between the cell phone of the accessing client and a telephone (i.e., the number listed). And instant message icon may be selected to initiate a process of instant messaging, including presenting a keyboard function in the UI to enable the client to type a message to be sent to the client to be accessed. (textual communication). A mail icon also is presented in the client side UI that is selected to initiate an email communication process, i.e., the accessing client's cell phone browser is initiated, including initiating the accessing client's email service, allowing the client to initiate, prepare, send and receive email communications with the selected client to be accessed.

Preferably, the client side application, upon login, is provided with a an simple streamlined directory object that is stored in the client cell phone, is accessed and navigated by the client through the client side UI. The once an entity and entity client to be accessed is selected, the above-described communication is enabled.

### BRIEF DESCRIPTION OF THE DRAWINGS

The present invention can best be understood in connection with the accompany drawings, in which:

FIG. 1A presents a block diagram representing one embodiment of a computer system of the invention;

FIG. 1B is a schematic representation of a tree structure representing the searchable registered business information including aspect information and designated aspect-related personnel contact data, as the data are indexed stored and retrieved in a database;

FIG. 2A is a block diagram representing the FIG. 1B tree structure;

FIG. 2B depicts the FIG. 2A tree structure in greater detail in order to highlight the various aspects of a registered business;

FIG. 3 is a detailed tree diagram portion of the tree diagram of FIGS. 2A and 2B;

FIG. 4 is a block diagram of the FIG. 1 system, highlighting parallel options for various categories of organizations listed in the cell phone register;

FIG. 5A is a schematic block diagram of a server in which a method the invention may be implemented; and

FIG. 5B is one example of a computer readable medium in which are embedded executed programs for execution by a computer to implement the method of the invention.

### DETAILED DESCRIPTION OF THE PREFERRED EMBODIMENTS

The following is a detailed description of example embodiments of the invention depicted in the accompanying drawing. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

The invention relates broadly to wireless telephone applications and more specifically relates to a client-server system in which access to and navigation within a database operating as business directory and information service is provided to cell-phone clients through a unique user interface that enables the cell phone clients to identify a business registered therein, based on business interest, location, class and/or name, search information provided by the business for sales, marketing, customer relations, technical, billing, financial, research & development (R&D) services (without limitation) to access identity and contact information of personnel designated for client contact regarding the services. Preferably, the designated personnel contact information comprises a telephone number to a cell phone provided by the business and/or an email address accessible through an e-mail service, also provided by the business.

The inventive system is advantageous because it enables quick review of an entity's various locations, sales values, related subsidiaries and management with the closest selected names and cell phone numbers associated therewith. The cell phone register allows clients, customers to get in direct contact with the specific company personnel. Independent sale representatives having their name and number associated with their respective companies can have clients and customers communicate directly, increasing business opportunities. The general public or interested parties requiring access to company/business personnel may get in contact directly and immediately, after registering and securely logging in, thus improving efficiency and effectiveness, saving time, contributing to improved business and commerce.

The database essentially operates as a register with many categories. Cell phone numbers and names may be accessible by: Web cell phone register and on application (app) so that a user can identify:

a) Companies, businesses, organizations, associations;

b) Professional organizations and associations;

c) Company representatives and sales personnel;

d) Independent representatives and sales personnel;

e) Clubs, professional, sport, social, school, colleges associations and organizations; and,

f) Government, Federal, State, Municipal, Local, public authorities, transportation, ports, airports, trail authorities, highway authorities, water districts, school boards, fire departments, police and prison security personnel, medical organizations, doctors, hospitals.

Any business-associated cell phone holder or owner can be included in this directory of cell phone numbers. The names the holders or owners may be listed categorically or alphabetically. The listing also includes the owners e-mail address should the listed require so. Preferably, cell phone listing would include individual, company, business, institution, organization, public body, Federal, State and Local government personnel, schools, unions, charitable organizations, alumni organizations, insurance company, law enforcement holders of company provided cell phones, who would like their business associated, or potential customers to have access to their sales or representatives' personnel.

The invention thereby allows direct contact with company or organizational personnel. Potential customers (i.e., system clients) may contact the relevant salesperson or service provider directly. The inventive cell phone database register provides direct person-to-person contact in the organization, association, business or company, and may result in increased sales, allowing interested persons to get in contact with the salesperson or service provided needed for particular tasks. The inventive cell phone database register enables persons wanting to speak with a certain person in a business to identify with and communicate with the desired person, by identification of a particular company, business, industry, location and name of the most appropriate person to help the user, so that the register supplies the cell number of the appropriate person needed. The inventive cell phone database register also enables a user to identify what particular items a company sells, and identifies the particular sales persons associated with sales of that particular item sought to be purchased. The inventive cell phone database register also saves time seeking the name and/or number of cell phone holder and allows direct communications to those seeking information about a particular item or product.

The inventive operation increases business by directing customers to sales personnel and shortens contact closing time, renders corporate and public officials more readily available, increases communications, increases business opportunities, provides knowledge that when a user knows the identity of a company that a user is seeking, together with the location, the user will also locate any representative of the company or organization , including the identity and cell phone numbers of persons who have a specialty in sales or other tasks, generate more sales for businesses and companies, gets assistance filing out government forms (federal, state, local municipal), enables users to apply for licenses, enables students to apply for scholarships, enable users to inquire about government services and provides users with the identities of the cell phone numbers of those whose job it is to help and assist the general public.

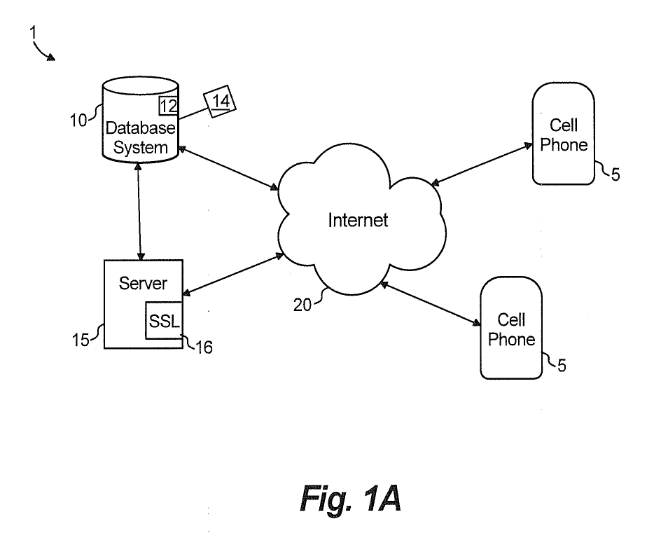

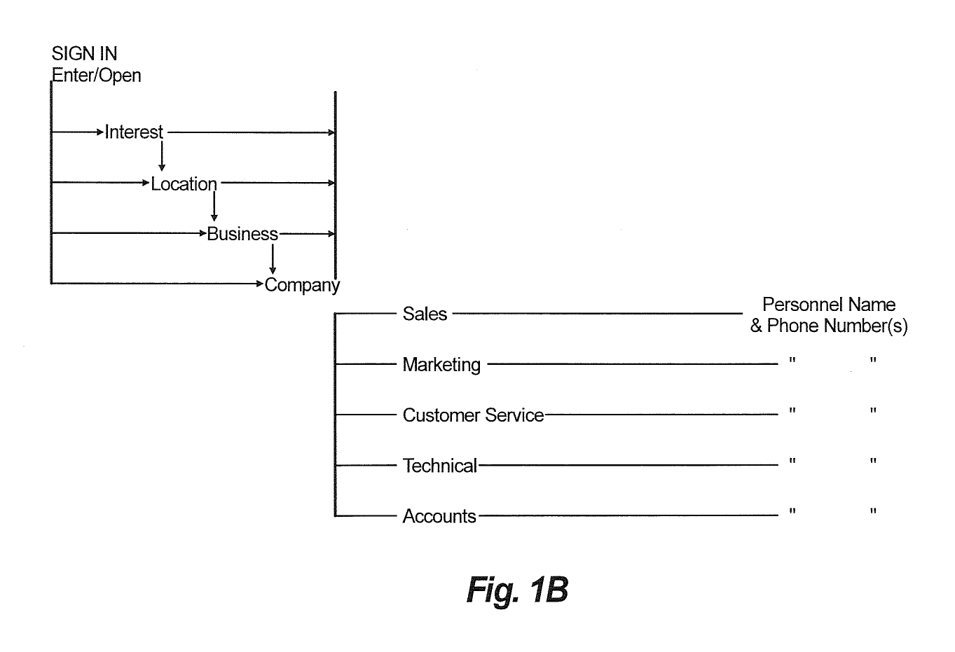

FIG. 1A presents a block diagram representing one embodiment of a computer system 1 configured to provide a user interface (UI) function to cell phones 5 to enable the cell phones to access to a database system 10 configured as a business directory and information service in order to search and identify registered businesses based on a business class, location or name and search stored business information related to the identified business in order identity contact data for personnel designated for client contact in relation to the stored information. The database system 10 is configured to manage indexing, storing and retrieving the business information and contact data.

A computer server 15 is programmed to operate a server-side application program to control access to and manage the database system 10 and information stored therein by cell phone clients. The computer server 15 operates the user interface (UI) function and a communication function that establishes and manages secure communications with client-side application program operating in client cell phones 5. The user interface enables the client to search the stored business information for business personnel most closely associated with the searched business and access the contact data for the business personnel.

The stored business information searchable by the user interface (UI) is classified as any of the group of business activities consisting of sales, marketing, customer relations, technology, billing, financials, research & development (R&D). The contact data are presented by the user interface (UI) that enables the client (i.e., the client-side application running or operating in the client cell phone communicating with the server) to execute an action initiating instant contact to said business personnel. Preferably, the user interface (UI) provides an icon representing a telephone number of said business personnel or an icon representing an email link to said business personnel or both, in a display screen on the client cell phone 5. Most preferably, the user interface (UI) provides a widget that is activated to initiate an instant, direct telephone call to said business personnel or a widget that is activated to initiate email communication to said business personnel or a widget that is activated to initiate an instant text message to said business personnel or a combination of the widgets.

While FIG. 1 shows the server 15, the database system 10 and the cell phones wirelessly interconnected via the Internet 20, database system 10 also is shown connected directly to the server 15. This connection may be a network connection either directly or indirectly. Perhaps more importantly, the cell phones 5 may be connected to the Internet 20 by any wireless means know to the skilled artisan, or even connected via satellite to the server 15 and data base. The server 15 preferably operates a website and the UI and client side application program cooperate with a browser in the cell phones 5 to access the server, website and server-side application. For that matter, the communication function relies on secure socket layer (SSL) technology, i.e., SSL 16, and protocol to establish an encrypted link between the server 15 and the client cell phone 5. The clients log into the website to establish the encrypted link. The database system includes at least one of internal memory 12 and external memory 14.

FIG. 1B is a schematic representation of a tree structure representing the searchable registered business information including aspect information and designated aspect-related personnel contact data, as the data are indexed stored and retrieved in a database. FIG.

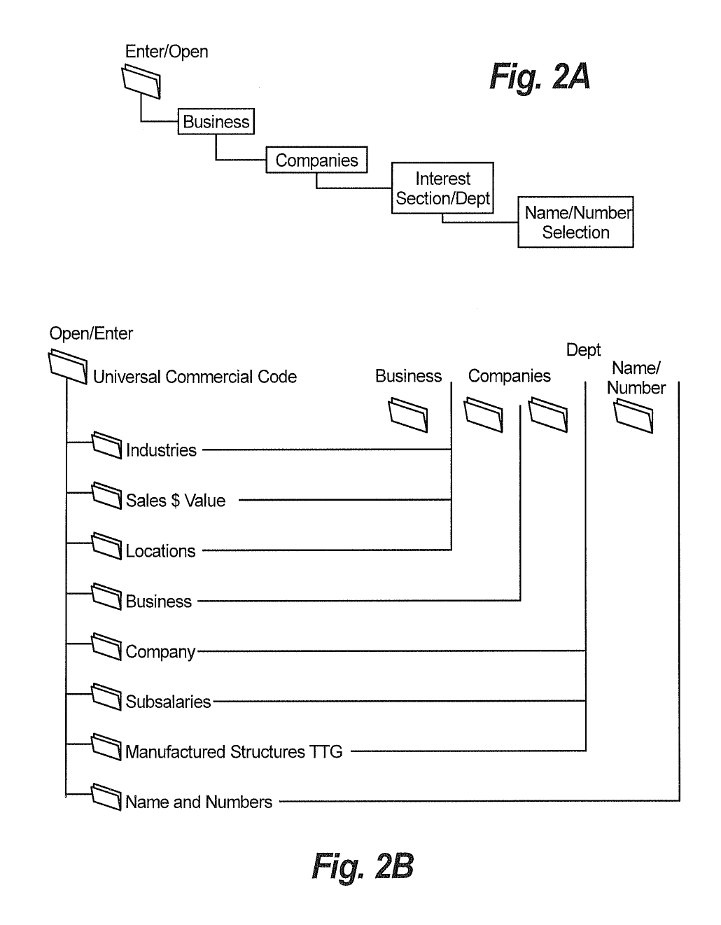

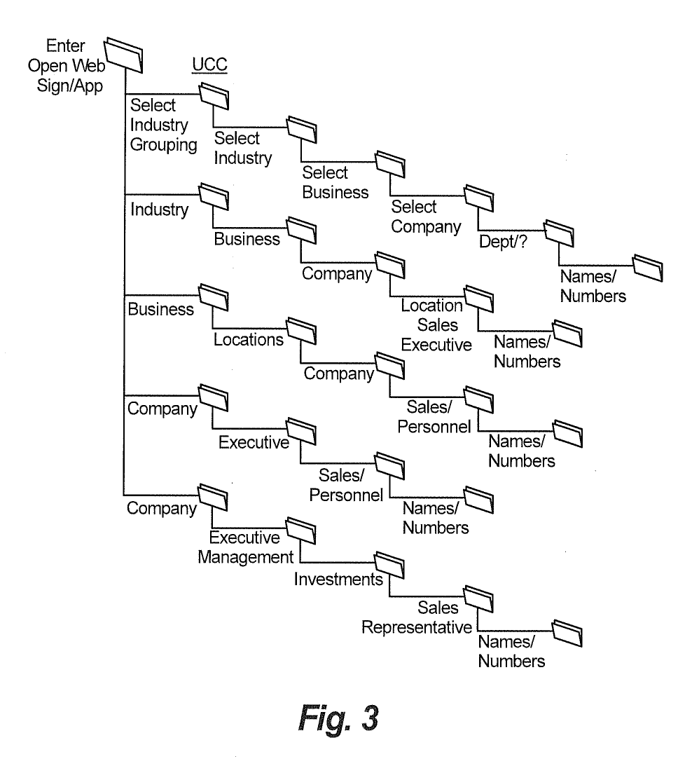

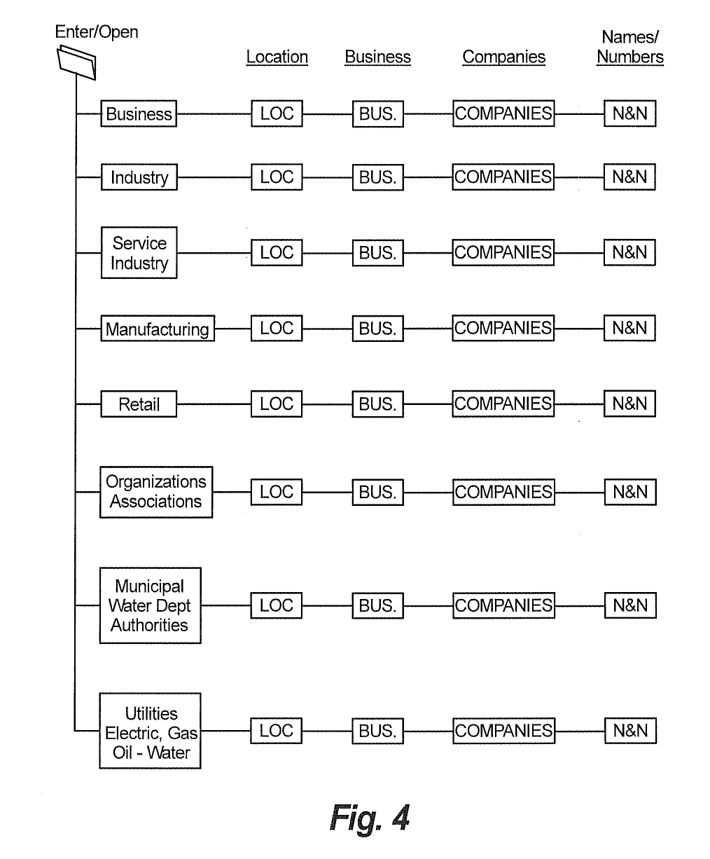

2A is a block diagram representing the FIG. 1B tree structure. FIG. 2B depicts the FIG. 2A tree structure in greater detail in order to highlight the various aspects of a registered business. FIG. 3 is a detailed tree diagram portion of the tree diagram of FIGS. 2A and 2B. FIG. 4 is a block diagram of the FIG. 1 system, highlighting parallel options for various categories of organizations listed in the cell phone register;

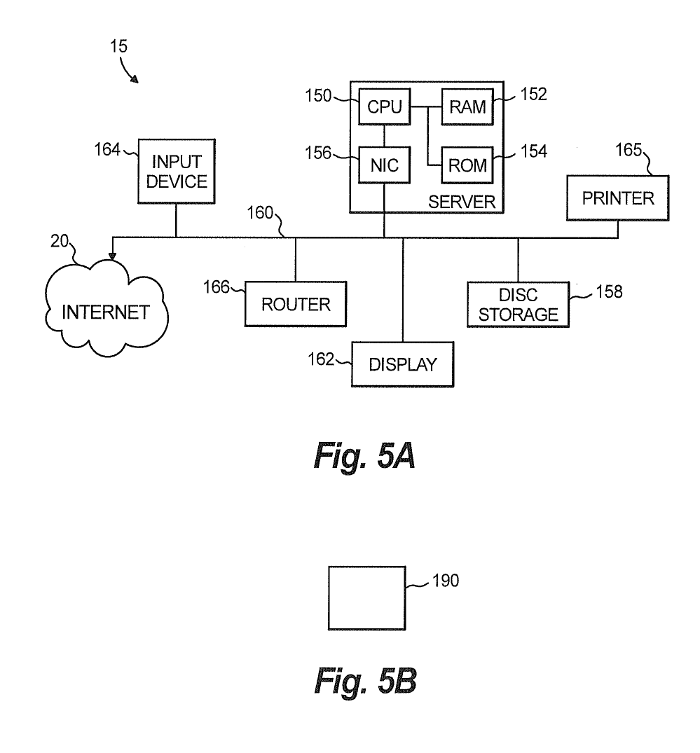

FIG. 5A depicts server system 15 in greater detail, which is programmed to implement the cell phone register system of the invention, as explained in detail above. The server 15 includes a central processing unit 150, a Random Access Memory (RAM) 152, a Read Only Memory (ROM) 154 and a network interface card 156. The ROM 154 includes the computer-readable instructions comprising the server-side application program and the client-side application program, downloaded to the client cell phones for intended operation. But the instructions themselves may also be stored in RAM 152, disc storage 158 or downloaded from an outside source or a computer program product 190 (FIG. 5B). The computer program product comprises media, for example, a non-transitory compact storage medium such as a compact disc or USB thumb drive.

The server system 15 also includes a bus 160, shown interconnected to a display device 162, and input device 164, a printer 165, a router 166 and the Internet 20. The display device may comprise a touch screen, where the input device 164 may comprise a keyboard, mouse, pen device or voice activated input device. For that matter, while shown hard-wired, the various components of server 15 may be wirelessly interconnected.

It is further noted that “computer program”, “software program”, “application program” (whether server side or client side), or “software”, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer instructions implementing the server functionalities, the computer instructions implementing the database functionalities and the computer instructions implementing the client side mobile application together cooperate to implement the inventive method.

In a method embodiment, the invention comprises a set of computer readable instructions that are memory stored. When operated upon by a computer processor, the computer readable instructions allow the server to register businesses, stored the business information, login clients, downloaded the instructions comprising he client side application, and operate an electronic registry in which information about registered businesses including contact data for personnel associated with various aspects of the registered business to be stored to enable the client-side application program operating in a client cell phone to access the registry in order to search and identify contact data for personnel designated by the business as a liaison for one or more of the various business aspects.

The method includes operating a database to manage indexing, storing and retrieving the business information and contact data, managing secure communications with and between the database and a client-side application program operating in a client cell phone to enable the client to search the stored business information for a business liaison most closely associated with a registered business or one or more of the various aspects associated with the registered business and operating a user interface (UI) that enables client cell phones to search the database to identify the business or the one aspect and access contact data for the liaison designated therewith.

The step of operating the database includes operating a secure server and website, where the step of operating the user interface (UI) includes enabling client access to the database after executing a login process. After login, the user interface (UI) enables the client to activate communication with the liaison using the identified contact data. The communication includes activating any of conventional telephone call, a text message, or an email message. Preferably, the UI provides widgets that are activated to initiate any of the conventional telephone call, the text message or the email message to the designated business liaison.

The method may further comprise a step of configuring the business directory and information service with the business information including designated liaison contact data and/or a step of registering the client and downloading the client-side application at a first time login by the client.

The invention also may include a computer program product embodying a non-transitory computer readable medium encoded with instructions executable by a processor to implement a method for operating an electronic registry in which information about a registered business including contact data for personnel associated with various aspects of the registered business is stored to enable an application program operating in a client cell phone to access the registry in order to search and identify contact data for personnel designated by the business as liaison. The method includes implementing the above-mentioned steps.

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A computer system that provides a user interface (UI) enabling cell phone access to a database system configured as a business directory and information service in order to search and identify registered businesses based on a business class, location or name and search stored business information related to the identified business in order identity contact data for personnel designated for client contact in relation to the stored information, the system comprising:
a database system programmed to manage indexing, storing and retrieving the business information and contact data; and
a computer server that operates the user interface (UI) and a communication function that establishes and manages secure communications with client-side application program operating in a client cell phone to enable the client to search the stored business information for business personnel most closely associated with the searched business and access the contact data for said business personnel.

2. The computer system as set forth in claim 1, wherein the stored business information searchable by the user interface (UI) is classified as any of the group of business activities consisting of sales, marketing, customer relations, technology, billing, financials, research & development (R&D).

3. The computer system as set forth in claim 1, wherein the contact data are presented by the user interface (UI) that enables the client to execute an action initiating instant contact to said business personnel.

4. The computer system as set forth in claim 3, wherein user interface (UI) provides an icon representing a telephone number of said business personnel or an icon representing an email link to said business personnel or both.

5. The computer system as set forth in claim 3, wherein user interface (UI) provides a widget that is activated to initiate an instant, direct telephone call to said business personnel or a widget that is activated to initiate email communication to said business personnel or a widget that is activated to initiate an instant text message to said business personnel or a combination of the widgets.

6. The computer system as set forth in claim 1, wherein the server and the database are connected as a network.

7. The computer system as set forth in claim 1, wherein the server operates a website accessible via the Internet.

8. The computer system as set forth in claim 9, wherein the communication function relies on secure socket layer (SSL) technology and protocol to establish an encrypted link between the server and the application program in the client cell phone.

9. The computer system as set forth in claim 8, wherein the client logs into the website to establish the encrypted link.

10. The computer system as set forth in claim 1, wherein the database system includes at least one of external and internal memory.

11. The computer system as set forth in claim 1, wherein the server and the database are connected as a network.

12. A computer-implemented method for operating an electronic registry in which information about registered business including contact data for personnel associated with various aspects of the registered business is stored to enable an application program operating in a client cell phone to access the registry in order to search and identify contact data for personnel designated by the business as a liaison for one or more of the various business aspects, the method comprising the steps of:
operating a database to manage indexing, storing and retrieving the business information and contact data;
managing secure communications with and between the database and a client-side application program operating in a client cell phone to enable the client to search the stored business information for a business liaison most closely associated with a registered business or one or more of the various aspects associated with the registered business; and
operating a user interface (UI) that enables client cell phones to search the database to identify the business or the one aspect and access contact data for the liaison designated therewith.

13. The computer-implemented method as set forth in claim 12, wherein the step of operating the database includes operating a secure server and website.

14. The computer-implemented method as set forth in claim 12, wherein the step of operating the user interface (UI) includes enabling client access to the database after executing a login process.

15. The computer-implemented method as set forth in claim 14, wherein after login, the user interface (UI) enables the client to activate communication with the liaison using the identified contact data.

16. The computer-implemented method as set forth in claim 15, wherein the communication includes activating any of conventional telephone call, a text message, or an email message.

17. The computer-implemented method as set forth in claim 15, wherein the UI provides widgets that are activated to initiate any of the conventional telephone call, the text message or the email message to the designated business liaison.

18. The computer implemented method as set forth in claim 12, further comprising a step of configuring the business directory and information service with the business information including designated liaison contact data.

18. The computer implemented method as set forth in claim 12, further comprising a step of registering the client and downloading the client-side application at a first time login by the client.

20. A computer program product embodying a non-transitory computer readable medium encoded with instructions executable by a processor to implement a method for operating an electronic registry in which information about a registered business including contact data for personnel associated with various aspects of the registered business is stored to enable an application program operating in a client cell phone to access the registry in order to search and identify contact data for personnel designated by the business as liaison, the method comprising the steps of:
operating a database to manage indexing, storing and retrieving the business information and contact data;
managing secure communications with and between the database and a client-side application program operating in a client cell phone to enable the client to search the stored business information for a business liaison most closely associated with a registered business or one or more of the various aspects associated with the registered business; and
operating a user interface (UI) that enables client cell phones to search the database to identify the business or the one aspect and access contact data for the liaison designated therewith.
